(19) United States
(12) Patent Application Publication
(10) Pub. No.: US 2025/0086250 A1
(43) Pub. Date: Mar. 13, 2025

(54) BUNDLING HYPERVECTORS USING ELEMENT-WISE SELECTIONS

(71) Applicant: INTERNATIONAL BUSINESS MACHINES CORPORATION, ARMONK, NY (US)

(72) Inventors: Aleksandar Terzic, Dietikon (CH); Jovin Langenegger, Gerlikon (CH); Michael Andreas Hersche, Zurich (CH); Abu Sebastian, Adliswil (CH); Abbas Rahimi, Rueschlikon (CH); Kumudu Geethan Karunaratne, Adliswil (CH)

(21) Appl. No.: 18/464,325

(22) Filed: Sep. 11, 2023

(51) Int. Cl. G06F 17/16; G06F 5/01; G06F 7/50

(52) U.S. Cl. CPC G06F 17/16; G06F 5/01; G06F 7/50

(57) ABSTRACT

An approach for bundling a set of hypervectors may be provided herein. The approach may involve encoding a data structure into a plurality of hypervectors. The approach may further involve calculating the element-wise sum of a set of hypervectors to generate a sum hypervector. A plurality of blocks may be produced from the sum hypervectors. The block elements of the sum hypervector may be selected based on a selection criterion. A selection criterion may include a threshold value or simply be the largest element per block. Additionally, the approach may involve setting the non-selected elements of the sum hypervector to zero.

### BACKGROUND

The present invention relates to the field of digital computer systems, and more specifically, to a method for bundling hypervectors using element-wise selections.

Hypervectors may be factorized using resonator networks and bundling operations. Resonator networks are a type of recurrent neural network that interleaves vector symbolic architecture multiplication operations and pattern completion. Given a hypervector formed from an element-wise product of two or more atomic hypervectors (each from a fixed codebook), the resonator network may find its factors. The resonator network may iteratively search over the alternatives for each factor individually rather than all possible combinations until a set of factors is found that agrees with the input hypervector.

### SUMMARY

Various embodiments provide a method for bundling hypervectors, computer program product and computer system as described by the subject matter of the independent claims. Advantageous embodiments are described in the dependent claims. Embodiments of the present invention can be freely combined with each other if they are not mutually exclusive.

In one aspect, the invention relates to a method for bundling a set of hypervectors. The method comprises: calculating the element-wise sum of the set of hypervectors, resulting in a sum hypervector; determining blocks of the sum hypervector; selecting per block, elements of the sum hypervector that fulfill a selection criterion; setting non-selected elements of the sum hypervector to zero, resulting in a bundled hypervector.

In one aspect the invention relates to a computer program product comprising a computer-readable storage medium having computer-readable program code embodied therewith, the computer-readable program code configured to implement the method of the above embodiment.

In one aspect the invention relates to a computer system for bundling a set of hypervectors. The computer system is configured for: calculating the element-wise sum of the set of hypervectors, resulting in a sum hypervector; determining blocks of the sum hypervector; selecting per block elements of the sum hypervector that fulfill a selection criterion; setting non-selected elements of the sum hypervector to zero, resulting in a bundled hypervector.

In one aspect the invention relates to calculating a sum hypervector, wherein the sum hypervector is an element-wise sum from a set of hypervectors. The aspect may further relate to determining a plurality of blocks of the sum hypervector. Further yet, the aspect may relate to selecting from each of the plurality of blocks one or more elements of the sum hypervector based on a selection criterion. Also, the aspect may relate to setting non-selected elements of the sum hypervector to zero.

### BRIEF DESCRIPTION OF THE DRAWINGS

FIG. 1 is a flowchart of a method for bundling a set of hypervectors, in accordance with an embodiment of the present invention.

FIG. 2 is a diagram illustrating a resonator network system, in accordance with an embodiment of the present invention.

FIG. 3 is a diagram illustrating the bundling operation, in accordance with an embodiment of the present invention.

FIG. 4 is a diagram illustrating the bundling operation, in accordance with an embodiment of the present invention.

FIG. 5 is a diagram illustrating the binding operation, in accordance with an embodiment of the present invention.

FIG. 6 is a flowchart of a method for factorizing a hypervector, in accordance with an embodiment of the present invention.

FIG. 7 is a diagram illustrating a method for image classification, in accordance with an embodiment of the present invention.

FIG. 8 is a diagram illustrating a method for image segmentation, in accordance with an embodiment of the present invention.

FIG. 9 depicts performance plots, in accordance with an embodiment of the present invention.

FIG. 10 is a block diagram depicting a computing environment for bundling hypervectors, in accordance with an example of the present subject matter.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

The descriptions of the various embodiments of the present invention will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Hyperdimensional computing (HDC) represents data as large vectors called hypervectors. An entity may be represented using these hypervectors. A hypervector may be a vector of bits, integers, real or complex numbers. The hypervector is a vector with a dimension D higher than a minimum dimension, e.g., D>100. The hypervector according to the present subject matter may be sparse hypervector. The sparse hypervector may comprise a fraction of non-zeros which is smaller than a predefined maximum fraction (e.g., the maximum fraction may be 10%). The sparsity of the hypervectors may be chosen or may be dictated by the encoder (e.g., such as a neural network) that produced the hypervectors. HDC may enable computations on hypervectors via a set of mathematical operations. These operations may include a bundling operation. The bundling operation may also be referred to as addition, superposition, chunking, or merging. The bundling operation may combine several hypervectors into a single hypervector. The present subject matter may enable an efficient bundling of hypervectors with arbitrary sparsity. In one example, the bundling operation may be performed as follows: given hypervectors A, B and C of size D each, the bundling operation B=A+C, may be performed as follows: each of the hypervectors A and C may be segmented into S blocks, the element wise sum of the hypervectors A and C may be performed to obtain the sum hypervector B, elements of each block of the sum hypervector B that fulfill the selection criterion may be selected, and may thus preserved and the non-selected elements may be set to zero in the sum hypervector B.

In one example, the hypervector may be segmented according to the present subject matter into a set of blocks so that a hypervector comprises a set of S blocks, each block having a dimension L, wherein D=S×L and S is the number of blocks in a hypervector. In one example, the hypervector may comprise a number S of blocks, wherein the block size may be higher than one, L>1. That is, each block of each hypervector may comprise L elements. The processing of the hypervectors may be performed blockwise.

According to one example, the hypervector comprises binary values {0, 1}^{D} and has a sparsity smaller than a sparsity threshold. The sparsity may, for example, the fraction of non-zero values in the hypervector. The present subject matter may enable an efficient bundling of hypervectors with controlled sparsity. According to one example, the sparsity threshold being in a range of: 0.3%-50%. Example values of the sparsity threshold may be 0.39%, 0.4%, 1% or 13%.

According to one example, the selection criterion requires a predefined number a of largest elements per block of the sum hypervector. The number a may be smaller than the size L of the block, a<L. The largest a elements of each block may be selected. For that, the elements of each block may be ranked and the first ranked a elements may be selected. If two or more elements are ranked the last of the top a, one of them may be selected randomly. In one example, the predefined number a may be a hyperparameter of randomly selected value or may be a user defined value. This example may enable a bundling procedure which may have a significantly larger bundling capacity compared to the existing bundling operations.

According to one example, the selection criterion requires the element of the block exceeds a threshold value, wherein if no element exceeds the threshold value in a block, all elements of the block are selected. This example may provide a threshold-based bundling operation which may be more amenable to hardware implementations as it may reduce to element-wise comparisons.

According to one example, the method further comprises normalizing the bundled hypervector per block. The normalization may, for example, be performed per block by computing the sum of elements of the block and dividing each element of the block by the computed sum.

According to one example, the binding operation of hypervectors may be a circular convolution of the hypervectors. The hypervector on which the binding operation is performed may, for example, result from the bundling operation of initial hypervectors according to the present method. According to one example, the unbinding operation of hypervectors may be a circular correlation of the hypervectors.

The present bundling operation, binding operation and unbinding operation may be used in several fields of application.

In one first example application, online hyperdimensional learning may use the present bundling. According to one example, the bundling is performed for online hyperdimensional learning, wherein the set of hypervectors to be bundled comprises the encoded hypervector [symbol] and the model hypervector [symbol] which are involved in hyperdimensional learning. This example may enable HDC classification. HDC maps data points into high-dimensional space and then performs a training to learn a model. For that, model classes may be defined and a single hypervector may be created for each class. Assuming, for example, that the model represents k classes with k class/model hypervectors [symbol] , [symbol] . . . [symbol] . During training, the HDC may map a data point into high-dimensional space to provide a so-called encoded hypervector [symbol] . The encoded hypervector [symbol] may be used to update one or more class hypervectors depending on its similarity with the class hypervectors. The update of the model hypervector [symbol] may be performed by using, for example, the scalar w e.g., w may indicate the similarity between [symbol] and the model hypervector [symbol] to be updated. The update may be performed as follows: [symbol] ←(1−w)× [symbol] +w× [symbol] . This update formula involves a bundling of the two weighted hypervectors (1−w)× [symbol] and w×H with weights w and 1−w. This bundling may be performed using the present method.

One second example of application may be resonator networks to factorize hypervectors. This example of application may be described as follows.

Data structures may enable to represent cognitive concepts, such as colours, shapes, positions, etc. Each cognitive concept may comprise items e.g., items of the colour concept may comprise red, green, blue etc. The data structure may contain a combination (e.g., product) of multiple components each representing a cognitive concept. For example, the data structure may be an image of a red disk in the bottom right and a green rectangle in the top left, wherein the cognitive concepts may be the colour, shape, and position. In another example, a data structure may form a distributed representation of a tree, wherein each leaf in the tree may represent a concept, and each type of traversal operations in the tree may represent concepts. The data structure may be encoded by an encoder into a hypervector that uniquely represents the data structure.

The encoder may combine hypervectors that represent individual concepts with operations to represent a data structure. For example, the above-mentioned image may be described as a combination of multiplication (or binding) and addition (or superposition) operations as follows: (bottom right*red*disk)+(top left*green*rectangle). The encoder may represent the image using hypervectors that represent the individual concepts and said operations to obtain the representation of the image as a single hypervector that distinctively represents the knowledge that the disk is red and placed at the bottom right and the rectangle is green and placed at the top left. The encoder may be defined by a vector space of a set of hypervectors which encode a set of cognitive concepts and algebraic operations on this set. The algebraic operations may, for example, comprise a superposition or bundling operation and a binding operation. In addition, the algebraic operations may comprise a permutation operation. The vector space may, for example, be a D-dimensional space, where D>100. The hypervector may be a D-dimensional vector comprising D numbers that define the coordinates of a point in the vector space. The D-dimensional hypervectors may be in {0,1}^{D}. For example, a hypervector may be understood as a line drawn from the origin to the coordinates specified by the hypervector. The length of the line may be the hypervector's magnitude. The direction of the hypervector may encode the meaning of the representation. The similarity in meaning may be measured by the size of the angles between hypervectors. This may typically be quantified as a dot product between hypervectors. The encoder may be a decomposable (i.e., factored) model to represent the data structures. This may be advantageous as the access to the hypervectors may be decomposed into the primitive or atomic hypervectors that represent the individual items of the concepts in the data structure. For example, the encoder may use a Vector Symbolic Architecture (VSA) technique to represent the data structure by a hypervector. The encoder may enable to perform an elementwise multiply operation. The encoder may, for example, comprise a trained feed-forward neural network.

Hence, the encoding of data structures may be based on a predefined set of F concepts, where F>1 and candidate items that belong to each of the F concepts. Each candidate item may be represented by a respective hypervector. Each concept may be represented by a matrix of the hypervectors representing candidate items of the concept, e.g., each column of the matrix may be a distinct hypervector. The matrix may be referred to as codebook and the hypervector representing one item of the concept may be referred to as code hypervector. The components of the code hypervector may, for example, be randomly chosen. For example, a codebook representing the concept of colours may comprise seven possible colours as candidate items, a codebook representing the concept of shapes may comprise 26 possible shapes as candidate items etc. The codebooks representing the set of concepts may be referred to as X₁, X₂ . . . X_{F} respectively. Each i-th codebook Xᵢ may comprise Mₓ_{ᵢ} code hypervectors xᵢ¹ . . . [symbol] , Mₓ_{ᵢ}>1.

Querying such data structures through their hypervector representations may require decoding the hypervectors. Decoding such hypervectors may be performed by testing every combination of code hypervectors. However, this may be very resource consuming. The present subject matter may solve this issue by using the resonator network. The resonator network may be an iterative approach. In particular, the resonator network can efficiently decode a given hypervector without needing to directly test every combination of factors making use of the fact that the superposition operation is used for the encoding of multiple concept items in the given hypervector and the fact that randomized code hypervectors may be highly likely to be close to orthogonal in the vector space, meaning that they can be superposed without much interference. For that, the resonator network may search for possible factorizations of the given hypervector by combining a strategy of superposition and clean-up memory. The clean-up memory may reduce some crosstalk noise between the superposed concept items. The resonator network combines the strategy of superposition and clean-up memory to efficiently search over the combinatorially large space of possible factorizations.

However, hypervectors may be sparse, meaning that they contain a small fraction of non-zeros. This may render the operations such as binding of hypervectors problematic and thus the factorization using the resonator network may not be accurate. The sparse hypervector may be a hypervector comprising a fraction of non-zeros which is smaller than a predefined maximum fraction (e.g., the maximum fraction may be 10%). The fraction of non-zeros may be the ratio of the non-zeros and the total number D of elements of the hypervector. The present subject matter may solve this issue by processing the hypervectors at block level rather than at individual element level during the iterative process. For that, the hypervector may be segmented according to the present subject matter into a set of blocks so that a hypervector comprises a set of S blocks, each block having a dimension L, wherein D=S×L. S is the number of blocks in a hypervector which may also be the number of non-zeros in the hypervector. The blocks may enable blockwise operations, that is, an operation involving hypervectors may be performed on corresponding blocks of the hypervectors e.g., an addition of two hypervectors may comprise addition of pairs of blocks of the two hypervectors, wherein each pair comprises two corresponding blocks (e.g., the first block of the first hypervector is to be processed with the first block of the second hypervector, the second block of the first hypervector is to be processed with the second block of the second hypervector, and so forth). The iterative process may process blockwise the hypervectors in one or more steps of the iterative process. These steps may involve binding and bundling operations. The blockwise binding and unbinding operations of two hypervectors x and y may be performed using the hypervectors. For example, the binding operation x⊙y, where ⊙ refers to the binding operation, may be performed using the circular convolution of hypervectors x and y. The unbinding operation x\textcircled{/}y, where \textcircled{/} refers to the unbinding operation, may be performed using the circular correlation of hypervectors x and y. The iterative process may stop if a convergence criterion is fulfilled. The convergence criterion may, for example, require a predefined number of iterations to be reached.

Assuming for a simplified description of the iterative process of the resonator network that the set of concepts comprises three concepts i.e., F=3, but it is not limited to. The codebooks/matrices representing the set of concepts may be referred to as X, Y and Z respectively (i.e., X=X₁, Y=X₂ and Z=X₃.). The codebook X may comprise Mₓ code hypervectors x¹ . . . x^{M}^{ₓ}. The codebook Y may comprise M_{y} code hypervectors y¹ . . . y^{M}^{_{y}}. The codebook Z may comprise M_{z} code hypervectors z¹ . . . z^{M}^{_{z}}. This may define a search space of size M=Mₓ·M_{y}·M_{z}. Since the resonator network is used, a data structure may be represented by a hypervector s which may be factorized into individual hypervectors representing the set of concepts respectively i.e., that is, the hypervector s may be defined as follows: s=x^{a}⊙y^{β}⊙z^{γ}. The iterative process may find x^{α}, y^{β}, z^{γ} where α∈{1, 2, . . . , Mₓ}, β∈{1, 2, . . . , M_{y}} and γ∈{1, 2, . . . , M_{z}}.

Given the hypervector s that represents the data structure and given the set of predefined concepts, an initialization step may be performed by initializing an estimate of the hypervector that represents each concept of the set of concepts. The initial estimates \hat{x}(0), ŷ(0) and \hat{z}(0) may, for example, be defined as a superposition of all candidate code hypervectors of the respective concept e.g. \hat{x}(0)=g(Σ_{i=1, . . . , M}_{ₓ}xⁱ), ŷ(0)=g(Σ_{j=1 . . . , M}_{_{y}}y^{j}) and \hat{z}(0)=g(Σ_{k=1, . . . , M}_{_{z}}z^{k}) where g is a selection function such as an argmax function. The term “estimate of a hypervector u” refers to a hypervector of the same size as hypervector u. The resonator network system may comprise a first buffer for storing the hypervector s and a second set of buffers for (initially) storing the estimates \hat{x}(0), ŷ(0) and \hat{z}(0).

And, for each current iteration t of the iterative process, the following may be performed. Unbound hypervectors \tilde{x}(t), \tilde{y}(t) and \tilde{z}(t) may be computed. Each of the unbound hypervectors may be an estimate of the hypervector that represents the respective concept of the set of concepts. Each of the unbound hypervectors may be inferred from the hypervector s based on the estimates of hypervectors for the other remaining F−1 concepts of the set of concepts. The unbound hypervectors may be computed as follows: \tilde{x}(t)=s [symbol] ŷ(t) [symbol] \hat{z}(t), \tilde{y}(t)=s [symbol] \hat{x}(t) [symbol] \hat{z}(t), and \tilde{z}(t)=s [symbol] \hat{x}(t) [symbol] ŷ(t), where [symbol] refers to the unbinding operation. The unbinding operation of two hypervectors may comprise a circular convolution of the two hypervectors. This may be referred to as an inference step.

The inference step may, however, be noisy if many estimates (e.g., F−1 is high) are tested simultaneously. The unbound hypervectors \tilde{z}(t), \tilde{y}(t) and \tilde{z}(t) may be noisy. This noise may result from crosstalk of many quasi-orthogonal code hypervectors, and may be reduced through a clean-up memory. After providing the unbound version of a hypervector of a given concept, the clean-up memory may be used to find the similarity of each code hypervector of said concept to the unbound version of the hypervector. This may be referred to as a similarity step. The similarity may be computed as a dot product of the codebook that represents said concept by the unbound version of the hypervector, resulting in an attention vector aₓ(t), a_{y}(t) and a_{z}(t) respectively. The attention vector may be referred to herein as similarity vector. The similarity vectors aₓ(t), a_{y}(t) and a_{z}(t) have sizes Mₓ, M_{y} and M_{z} respectively and may be obtained as follows: aₓ(t)=X^{T}\tilde{x}(t)∈ [symbol] , a_{y}(t)=Y^{T}\tilde{y}(t)∈ [symbol] and a_{z}(t)=Z^{T}\tilde{z}(t)∈ [symbol] . The obtained similarity vectors are provided using a dot product similarity; however, it is not limited to as other similarity metrics may be used and which may be implemented differently. For example, the similarity vector aₓ(t) may indicate a similarity of the unbound hypervector \tilde{x}(t) with each candidate code hypervector of the concept (X) e.g., the largest element of aₓ(t) may indicate the code hypervector which matches best the unbound hypervector \tilde{x}(t). The similarity vector a_{y}(t) may indicate a similarity of the unbound hypervector \tilde{y}(t) with each candidate code hypervector of the concept (Y) e.g., the largest element of a_{y}(t) may indicate the code hypervector which matches best the unbound hypervector \tilde{y}(t). The similarity vector a_{z}(t) may indicate a similarity of the unbound hypervector \tilde{z}(t) with each candidate code hypervector of the concept (Z) e.g., the largest element of a_{z}(t) indicates the code hypervector which matches best the unbound hypervector \tilde{z}(t).

A superposition (or bundling) using the similarity vectors aₓ(t), a_{y}(t) and a_{z}(t) as weights may be performed and optionally followed by the application of a selection function g. This may be referred to as the superposition step. This superposition step may be performed using the similarity vectors aₓ(t), a_{y}(t) and a_{z}(t) as follows: \hat{x}(t+1)=g(aₓ(t)X), ŷ(t+1)=g(a_{y}(t)Y) and \hat{z}(t+1)=g(a_{z}(t)Z) respectively, in order to obtain the current estimates \hat{x}(t+1), ŷ(t+1) and \hat{z}(t+1) respectively of the hypervectors that represent the set of concepts. In other words, the superposition step generates each of the estimates \hat{x}(t+1), ŷ(t+1) and \hat{z}(t+1) representing the respective concept by a linear combination of the candidate code hypervectors (provided in respective matrices X, Y and Z), with weights given by the respective similarity vectors aₓ(t), a_{y}(t) and a_{z}(t), and optionally followed by the application of the selection function g. The superposition step may involve a bundling operation which may be performed according to the present method. For example, the bundling operation may be performed by weighted additive superposition of code vectors, where the weights are given by the values of the similarity vector. The superposition may for example involve one or more bundling operations which are performed by the present method. Hence, the current estimates of the hypervectors representing the set of concepts respectively may be defined as follows: \hat{x}(t+1)=g(XX^{T} (s [symbol] ŷ(t) [symbol] \hat{z}(t))), ŷ(t+1)=g(YY^{T} (s [symbol] \hat{x}(t) [symbol] \hat{z}(t))) and \hat{z}(t+1)=g(ZZ^{T} (s [symbol] \hat{x}(t) [symbol] ŷ(t))), where g is the selection function, for example, an argmax function.

The iterative process may stop if a convergence criterion is fulfilled. The convergence criterion may, for example, require that the value of at least one element of each similarity vector aₓ(t), a_{y}(t) and a_{z}(t) exceeds a threshold. In another example, the convergence criterion may require a predefined number of iterations to be reached.

The present resonator implementation may mitigate the following limitations of an existing resonator. The existing sparse resonator may not factorize S=4 sparse hypervectors at problem sizes larger than M=10³ for a number 3 of codebooks and size of 10 per codebook. This may limit the deep neural network (DNN) application to problems with up to 10³ classes, making extreme classification problems (>100 k classes) not viable with S=4. The existing resonator may not factorize S=2 sparse hypervectors at any problem size. Concretely, at problem size M=1024, the existing resonator may achieve a less than 10% factorization accuracy. The architecture of the existing resonator may be rigid and may not allow for simple modification which may boost factorization accuracy depending on the problem at hand.

According to one example, the similarity step comprises sparsifying the similarity vector before the superposition step is performed on the sparsified similarity vector. That is, the similarity vectors aₓ(t), a_{y}(t) and a_{z}(t) are sparsified in order to obtain the sparsified similarity vectors a′ₓ(t), a′_{y}(t) and a′_{z}(t) respectively. The sparsification of the similarity vector may be performed by activating a portion of the elements of the similarity vector and deactivating the remaining portion of the elements of the similarity vector. Activating an element of the similarity vector means that the element may be used or considered when an operation is performed on the similarity vector. Deactivating an element of the similarity vector means that the element may not be used or considered when an operation is performed on the similarity vector. For example, a′ₓ(t)=kact(aₓ(t)), a′_{y}(t)=kact(a_{y}(t)) and a′_{z}(t)=kact(a_{z}(t)), where kact is an activation function. In this case, the superposition step described above may be performed on the sparsified similarity vectors a′ₓ(t), a′_{y}(t) and a′_{z}(t) (instead of the similarity vectors aₓ(t), a_{y}(t) and a_{z}(t)) as follows: x(t+1)=g(Xa′ₓ(t)), ŷ(t+1)=g(Ya′_{y}(t)) and \hat{z}(t+1)=g(Za′_{z}(t)), respectively, in order to obtain the current estimates \hat{x}(t+1), ŷ(t+1) and \hat{z}(t+1) respectively of the hypervectors that represent the set of concepts. In other words, the superposition step generates each of the estimates \hat{x}(t+1), ŷ(t+1) and \hat{z}(t+1) representing the respective concept by a linear combination of the candidate code hypervectors (provided in respective matrices X, Y and Z), with weights given by the respective sparsified similarity vectors a′ₓ(t), a′_{y}(t) and a′_{z}(t), followed by the application of the selection function g. The weights given by the sparsified similarity vector are the values of the sparsified similarity vector. Hence, the current estimates of the hypervectors representing the set of concepts respectively may be defined as follows: \hat{x}(t+1)=g(X kact(X^{T} (s [symbol] ŷ(t) [symbol] \hat{z}(t)))), ŷ(t+1)=g(Y kact(Y^{T} (s [symbol] \hat{x}(t) [symbol] \hat{z}(t)))) and \hat{z}(t+1)=g(Z kact(Z^{T} (s [symbol] \hat{x}(t) [symbol] ŷ(t)))).

This example may be advantageous because the sparsification may result in doing only a part of vector multiplication-addition operations instead of all Mₓ, M_{y} or M_{z} operations and thus may save processing resources.

In one first example, the activation function kact may only activate the top j values in each of the similarity vectors aₓ(t), a_{y}(t) and a_{z}(t), where j<<Mₓ, j<<M_{y} and j<<M_{z} respectively, and deactivate the rest of elements by setting them to a given value (e.g., zero) to produce a′ₓ(t), a′_{y}(t) and a′_{z}(t) respectively. The top j values of a similarity vector may be obtained by sorting the values of the similarity vector and selecting the j first ranked values. j may, for example, be a configurable parameter whose value may change e.g., depending on available resources.

This example may be advantageous because the sparsification may reduce the amount of computations, increase the size of solvable problems by an order of magnitude at a fixed vector dimension, and improve the robustness against noisy input vectors.

In a second example, the activation function kact may activate each element in each of the of the similarity vectors aₓ(t), a_{y}(t) and a_{z}(t) only if its absolute value is larger than a mean of all elements of the respective similarity vector. The mean is determined using the absolute values of the similarity vector.

This example may be advantageous because the sparsification may improve the computational complexity of the first embodiment by removing the sort operation needed to find the top-j elements.

In a third example, the activation function kact may be implemented as follows: in case the maximum value of the sparsified similarity vector exceeds a predefined threshold, the maximum value may be maintained and remaining elements of the sparsified similarity vector may be set to zero. This may be referred to as a pullup activation.

An embodiment of the present invention may efficiently factorize the hypervector representing a data structure into the primitives from which it is composed. For example, given a hypervector formed from an element-wise product of two or more hypervectors, its factors (i.e., the two or more hypervectors) may be efficiently found. This way, a nearest-neighbour lookup may need only search over the alternatives for each factor individually rather than all possible combinations. This may reduce the number of operations involved in every iteration of the resonator network and hence reduce the complexity of execution. This may also solve larger size problems (at fixed dimensions) and improve the robustness against noisy input hypervectors.

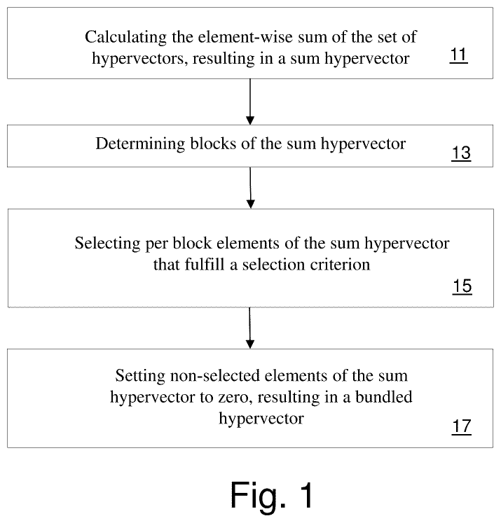

FIG. 1 is a flowchart of a method for bundling a set of hypervectors in accordance with an embodiment of the present invention.

The element-wise sum of the set of hypervectors may be computed in step 11. This may result in a hypervector named sum hypervector. The blocks of the sum hypervector may be determined in step 13. For example, the sum hypervector may be segmented into a defined number of blocks. Alternatively, the set of hypervectors may be segmented into the defined number of blocks, and the sum hypervector may automatically be configured in the block structure. Elements of each block of the sum hypervector that fulfill a selection criterion may be selected in step 15. The non-selected elements of the sum hypervector may be set in step 17 to zero in the sum hypervector, resulting in a bundled hypervector. The selected elements are preserved.

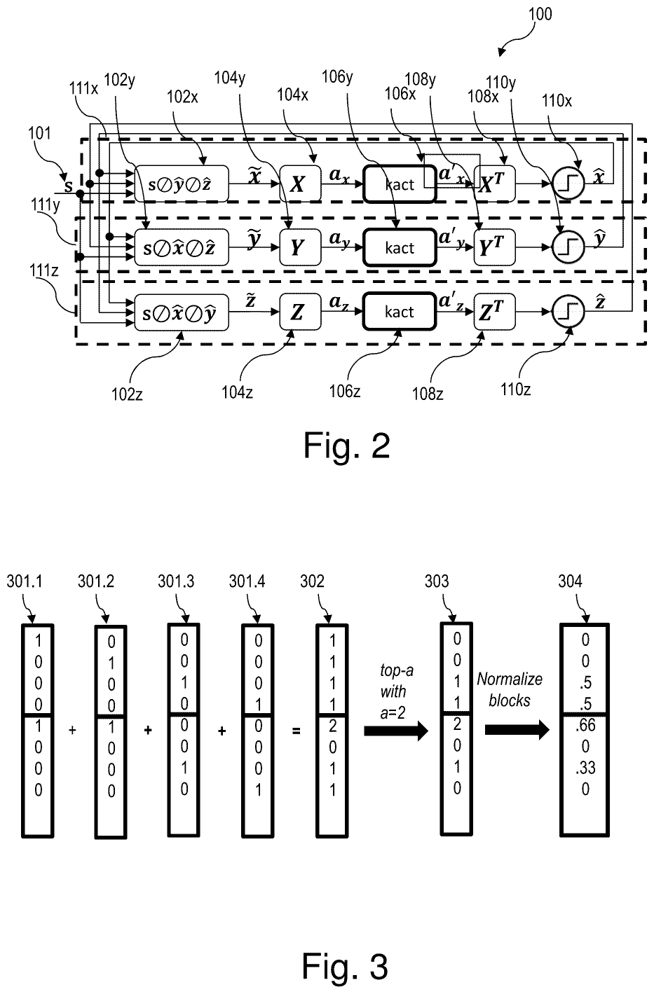

FIG. 2 is a diagram illustrating a resonator network system 100 in accordance with an embodiment of the present invention.

The resonator network system 100 may be configured to execute a resonator network to decode hypervectors that are encoded in a vector space defined by three concepts. The codebooks representing the set of concepts may be referred to as X, Y and Z respectively. The codebook X may comprise Mₓ code hypervectors x¹ . . . x^{M}^{ₓ}, Mₓ>1. The codebook Y may comprise M_{y} code hypervectors y¹ . . . y^{M}^{_{y}}, M_{y}>1. The codebook Z may comprise M_{z} code hypervectors z¹ . . . z^{M}^{_{z}}, M_{z}>1. This may define a search space of size M=Mₓ·M_{y}·M_{z}. The resonator network may be a recurrent neural network. Resonator network system 100 may comprise network nodes 102x, 102y and 102z that represent respectively the three concepts. Resonator network system 100 may further comprise memories 104x, 104y and 104z for storing the codebooks X, Y and Z respectively. Resonator network system 100 may further comprise computation units 108x, 108y and 108z comprising respectively memories for storing the transposes X^{T}, Y^{T} and Z^{T} of the codebooks respectively. Resonator network system 100 may further comprise activation units 106x, 106y and 106z for the three concepts respectively. Activation units 106x, 106y and 106z may implement the activation function kact according to the present subject matter. Resonator network system 100 may further comprise selection units 110x, 110y and 110z for the three concepts respectively. Selection units 110x, 110y and 110z may implement a selection function such as an argmax function. As indicated in FIG. 1, the concepts of the vector space may be associated with processing lines 111x, 111y and 111z respectively, wherein each processing line may provide an estimate of a hypervector representing the respective concept (e.g., the processing line 111x provides estimates x, the processing line 111y provides estimates ŷ and the processing line 111z provides estimates).

Input hypervector 101 shown as “s” may be received by resonator network system 100. The input hypervector s may be the result of encoding a data structure such as a coloured image comprising MNIST digits. The encoding may be performed by a VSA technique. At an initial state t=0 resonator network system 100 may initialize an estimate of the hypervector that represents each concept of the set of concepts as a superposition of all candidate code hypervectors of said concept as follows: \hat{x}(0)=g(Σ_{i=1, . . . , M}_{ₓ}xⁱ), ŷ(0)=g(Σ_{j=1, . . . , M}_{_{y}}yⁱ) and \hat{z}(0)=g(Σ_{k=1, . . . , M}_{_{z}}z^{k}), where g is the selection function.

The operation of resonator network system 100 may be described for a current iteration t. Network nodes 102x, 102y and 102z may receive simultaneously or substantially simultaneously the respective triplet (s, ŷ(t), \hat{z}(t)), (s, \hat{x}(t), \hat{z}(t)) and (s, \hat{x}(t), ŷ(t)). The three network nodes may compute the unbound versions \tilde{x}(t), \tilde{y}(t) and \tilde{z}(t) of the hypervectors that represent the set of concepts respectively as follows: \tilde{x}(t)=s [symbol] ŷ(t) [symbol] \hat{z}(t), \tilde{y}(t)=s [symbol] \hat{x}(t) [symbol] \hat{z}(t) and \tilde{z}(t)=s [symbol] \hat{x}(t) [symbol] ŷ(t), where [symbol] refers to blockwise unbinding. This may be referred to as an inference step. That is, the nodes may be perform the inference step on respective input triplets. The blockwise unbinding of hypervectors may be performed using the circular correlation between the hypervectors.

The similarity of the unbound version \tilde{x}(t) with each of the M_{y} code hypervectors x¹ . . . x^{M}^{ₓ} may be computed using the codebook X stored in memory 104x as follows: aₓ(t)=X^{T}\tilde{x}(t)∈ [symbol] for multiplying the hypervector \tilde{x}(t) by the matrix X^{T}. The similarity of the unbound version \tilde{y}(t) with each of the M_{y} code hypervectors y¹ . . . y^{M}^{_{y}} may be computed using the codebook Y stored in memory 104y as follows: a_{y}(t)=Y^{T}\tilde{y}(t)∈ [symbol] for multiplying the hypervector \tilde{y}(t) by the matrix Y^{T}. The similarity of the unbound version \tilde{z}(t) with each of the M_{z} code hypervectors z¹ . . . z^{M}^{_{z}} may be computed using the codebook Z stored in memory 104z as follows: a_{z}(t)=Z^{T}\tilde{z}(t)∈ [symbol] for multiplying the hypervector \tilde{z}(t) by the matrix Z^{T}. The resulting vectors aₓ(t), a_{y}(t) and a_{z}(t) may be named similarity vectors or attention vectors. The largest element of each of the similarity vectors aₓ(t), a_{y}(t) and a_{z}(t) indicates the code hypervector which matches best the unbound version \tilde{x}(t), \tilde{y}(t) and \tilde{z}(t) respectively.

After computing the similarity vectors, the similarity vectors aₓ(t), a_{y}(t) and a_{z}(t) may optionally be sparsified using the activation function kact implemented by the activation units 106x. 106y and 106z respectively. The sparsification of the similarity vector may be performed by activating a portion of the elements of the similarity vector. For that, the activation function kact may be used to activate said portion of elements as follows: a′ₓ(t)=kact(aₓ(t)), a′_{y}(t)=kact(a_{y}(t)) and a′_{z}(t)=kact(a_{z}(t)). The modified/sparsified similarity vectors a′ₓ(t), a′_{y}(t) and a′_{z}(t) may be the output of the similarity step. Thus, for each concept of the set of concepts, the similarity step may receive as input the respective one of the unbound versions \tilde{x}(t), \tilde{y}(t) and \tilde{z}(t) and provide as output the respective one of the modified similarity vectors a′ₓ(t), a′_{y}(t) and a′_{z}(t).

After obtaining the modified similarity vectors a′ₓ(t), a′_{y}(t) and a′_{z}(t), a superposition step may be applied on the modified similarity vectors a′ₓ(t), a′_{y}(t) and a′_{z}(t). In case the sparsification is not performed, the superposition step may be performed on the similarity vectors aₓ(t), a_{y}(t) and a_{z}(t).

In an embodiment, implementation of the superposition step, a weighted superposition of the modified similarity vectors a′ₓ(t), a′_{y}(t) and a′_{z}(t) may be performed using the codebooks X^{T}, Y^{T} and Z^{T} stored in memories 108x, 108y, and 108z respectively. This may be performed by the following matrix vector multiplications: Xa′ₓ(t), Ya′_{y}(t) and Za′_{z}(t). The resulting hypervectors Xa′ₓ(t)), Ya′_{y}(t)) and Za′_{z}(t) may be fed to the selection units 110x, 110y and 110z respectively. This may enable to obtain the estimate of the hypervectors \hat{x}(t+1), ŷ(t+1) and \hat{z}(t+1) respectively for the next iteration t+1 as follows: \hat{x}(t+1)=g(Xa′ₓ(t)), ŷ(t+1)=g(Ya′_{y}(t)) and \hat{z}(t+1)=g(Za′_{z}(t)). This may enable the superposition step of the iterative process. For each concept of the concepts the superposition step may receive as input the respective one of the modified similarity vectors a′ₓ(t), a′_{y}(t) and a′_{z}(t) and provides as an output the respective one of the hypervectors \hat{x}(t+1), ŷ(t+1) and \hat{z}(t+1). Hence, the estimate of the hypervectors representing the set of concepts respectively may be defined according to the present system as follows: \hat{x}(t+1)=g(X kact(X^{T} (s [symbol] ŷ(t) [symbol] \hat{z}(t)))), ŷ(t+1)=g(Y kact(Y^{T} (s [symbol] \hat{x}(t) [symbol] \hat{z}(t)))) and \hat{z}(t+1)=g(Z kact(Z^{T} (s [symbol] \hat{x}(t) [symbol] ŷ(t)))), where g is the selection function.

The iterative process may stop if a stopping criterion is fulfilled. The stopping criterion may, for example, require that \hat{x}(t+1)=\hat{x}(t), ŷ(t+1)=ŷ(t) and \hat{z}(t+1)=\hat{z}(t) or that a maximum number of iterations is reached.

FIG. 3 is a diagram illustrating the bundling operation in accordance with an embodiment of the invention. Four hypervectors 301.1 through 301.4 are to be bundled. Each hypervector of the four hypervectors 301.1 through 301.4 may comprise two blocks. The sum of the four hypervectors 301.1 through 301.4 may be performed element-wise to obtain the sum hypervector 302. A selection of the a-many largest elements per block of the sum hypervector 302 may be performed. In the example of FIG. 3, a=2. The selected elements are unmodified, while all others are set to 0. This may result in the hypervector 303. The blocks of the hypervector 303 are then normalized to obtain the bundled hypervector 304. This bundling procedure may have a significantly larger bundling capacity compared to the previous state-of-the-art. In this example, the bundling result 304 has non-zero similarity with all four input hypervectors 301.2 through 301.4.

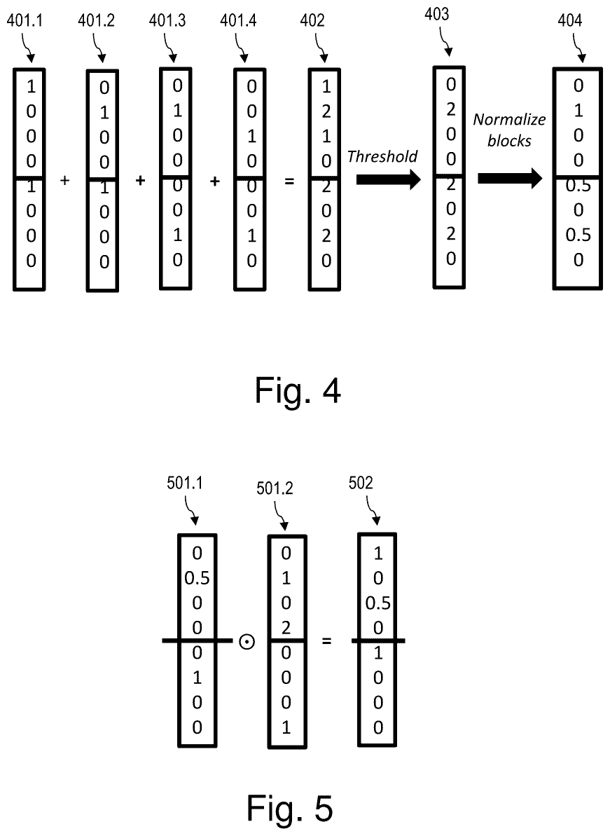

FIG. 4 is a diagram illustrating the bundling operation in accordance an embodiment of the invention. Four hypervectors 401.1 through 401.4 are to be bundled. Each hypervector of the four hypervectors 401.1 through 401.4 may comprise two blocks. The sum of the four hypervectors 401.1 through 401.4 may be performed element-wise to obtain the sum hypervector 402. All elements of the sum hypervector 402 may be compared with a fixed threshold value. The elements that exceed the threshold are preserved, while all others are set to 0. In each block, if no element exceeds the threshold, the entire block is preserved. This may result in the hypervector 403. The blocks of hypervector 403 are then normalized in order to obtain the bundled hypervector 404. This threshold-based bundling operation may be more amenable to hardware implementations as it may reduce to element-wise comparisons. The variance in the number of activated elements may be significantly larger than that of the top-a based implementation shown in FIG. 3.

FIG. 5 is a diagram illustrating the binding operation in accordance with an embodiment of the invention. A binding operation is performed on hypervectors 501.1 and 501.2. Each hypervector (i.e., hypervectors 501.1 and 501.2) may comprise two blocks. The binding operation of the hypervectors 501.1 and 501.2 may be performed by computing the circular convolution of the hypervectors 501.1 and 501.2. This may result in the bound hypervector 502. This binding operation may address the following limitation of existing technique. The existing binding operation for binary sparse block-codes may exploit a single active element per sparse block. This may significantly limit the maximum amount of information per hypervector. The unbinding operation may be performed using the circular correlation. The binding/unbinding may allow inputs with any sparsity level. The binding/unbinding may allow inputs with any floating-point value.

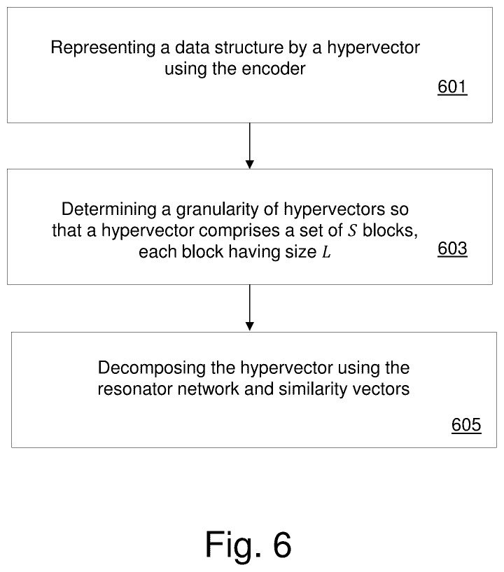

FIG. 6 is a flowchart of a method for factorizing a hypervector in accordance with an embodiment of the invention. The hypervectors may comprise zero values and non-zero (e.g., one) values.

In step 601, a data structure may be represented by hypervector s using an encoder (e.g., a VSA based encoder). For example, the data structure may be a query image representing a visual scene. The encoder may be a feed-forward neural network that is trained to produce the hypervector s as a compound hypervector describing the input visual image. The image may comprise coloured MNIST digits. The components of the image may be the colour, shape, vertical and horizontal locations of the letters in the image. The encoder may, for example, be configured to compute a hypervector for each letter in the image by multiplying the related quasi-orthogonal hypervectors drawn from four fixed codebooks of four concepts: colour codebook (with 7 possible colours), shape codebook (with 26 possible shapes), vertical codebook (with 50 locations), and horizontal codebook (with 50 locations). The product vectors for every letter are added (component-wise) to produce the hypervector s describing the whole image.

In step 603, a granularity of hypervectors may be determined so a hypervector comprises a set of S blocks, each block having size L≥1, wherein D=S×L. For example, the block size may be higher than one, L≥1. In other words, step 603 comprises determining for each hypervector a set of S blocks, each block having size L, where D=S×L. For example, the hypervector may be segmented or divided into a number of blocks that is equal to the number of non-zero values (e.g., non-zero value=1) in the hypervector so that each block may comprise one non-zero value. Each processed hypervector may have the same number S of blocks, but the positions/indices of the non-zero values within blocks may differ between the hypervectors.

In step 605, the hypervector s may be decomposed with the resonator network and the determined blocks. The resonator network can be configured to receive the input hypervector s and to perform an iterative process to factorize the input hypervector into individual hypervectors representing the set of concepts respectively. The iterative process for each concept of the set of concepts comprises: an inference step for computing an unbound version of a hypervector representing the concept by a blockwise unbinding operation between the input hypervector and estimate hypervectors of the other concepts, a similarity step to compute a similarity vector indicating a similarity of the unbound version with each candidate code hypervector of the concept, and a superposition step to generate an estimate of a hypervector representing the concept by a linear combination of the candidate code hypervectors, with weights given by the similarity vector. The superposition step may be performed using the bundling as described in FIG. 1. The iterative process may stop if a convergence criterion is fulfilled. In an embodiment, the convergence criterion may require a predefined number of iterations to be reached or the difference between the current estimate of a hypervector representing each concept and the last estimate of a hypervector representing said each concept is smaller than a threshold.

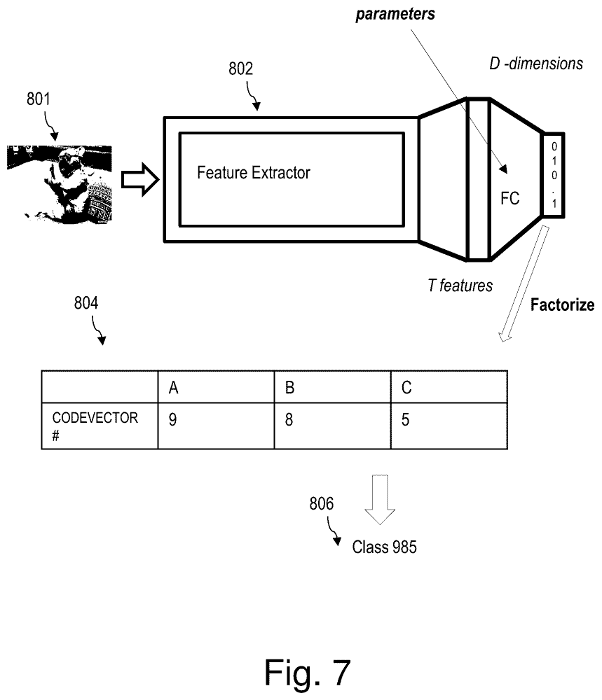

FIG. 7 is a diagram illustrating a method for image classification in accordance with an embodiment of the invention.

FIG. 7 depicts a classification problem with 1000 classes. Three factors (F=3) may be provided. Each of the three factors comes from a codebook of size M=10. The three codebooks are referred to as A, B and C in table 804. This induces M^{F}=1000 possible vector bindings. Feature extractor 802 maps input image 801 to a feature vector of T features. The feature vector is then mapped to one of the 1000 possible hypervector bindings via a fully connected (FC) layer. Extracted feature vectors may be mapped to hypervectors of fixed dimensionality D. The problem size M^{F} defines the number of supported classes. Since D does not depend on the problem size M^{F}, the number of parameters in the fully connected layer may be fixed to the number T×D. It does not grow with the number of classes. By factorizing the hypervector binding using the present method (e.g., using the resonator of FIG. 2) one can infer class 806 belonging of the input image. The class may be defined as the factors 9, 8 and 5 associated with the three codebooks A, B and C respectively.

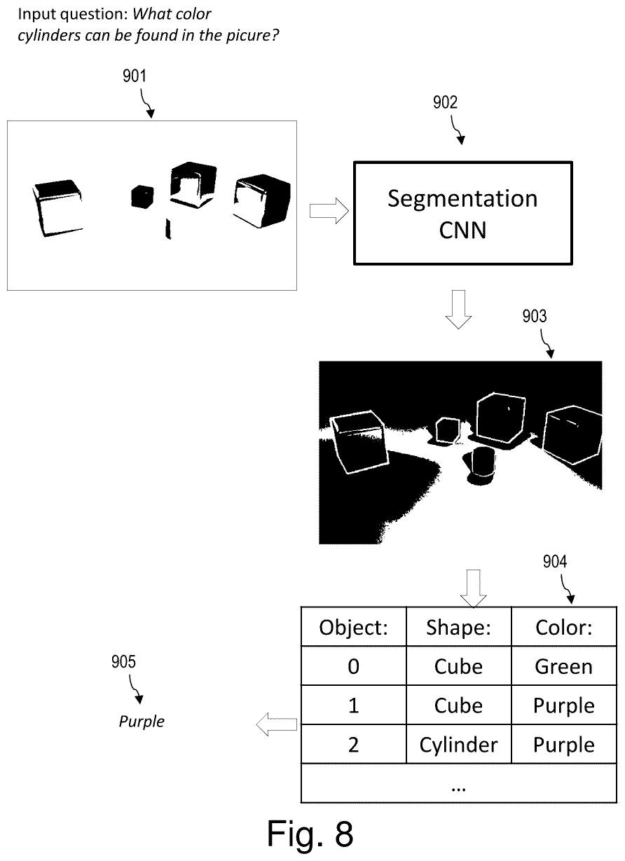

FIG. 8 is a diagram illustrating a method for image segmentation in accordance with an embodiment of the invention.

FIG. 8 depicts a classification problem with two codebooks. The first codebook represents object shape. The second codebook represents object colors. Input image 901 comprising objects of different shapes may be input to CNN 902 which is configured to perform image segmentation. The resulting segmented image 903 comprises the objects which are detected and surrounded with boxes. These objects may be represented with hypervectors. For example, a neural network may map segments of visual scenes 903 to the hypervectors. The training target vectors for image segments are bindings of hypervectors representing colours and hypervectors representing shapes. These hypervectors may be factorized according to the present subject matter to find the shape and the colour of each object (as shown with table 904) using the codebooks and associated code hypervectors. For example, the embodiments may indicate colour 905 of the cylinders in input image 901. This example may enable Neuro-Vector-Symbolic Visual Question Answering (VQA) algorithms.

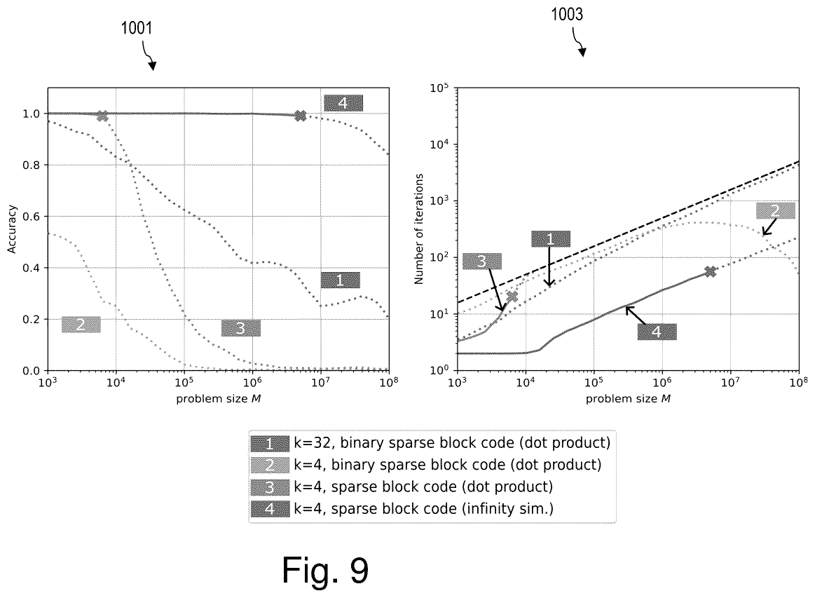

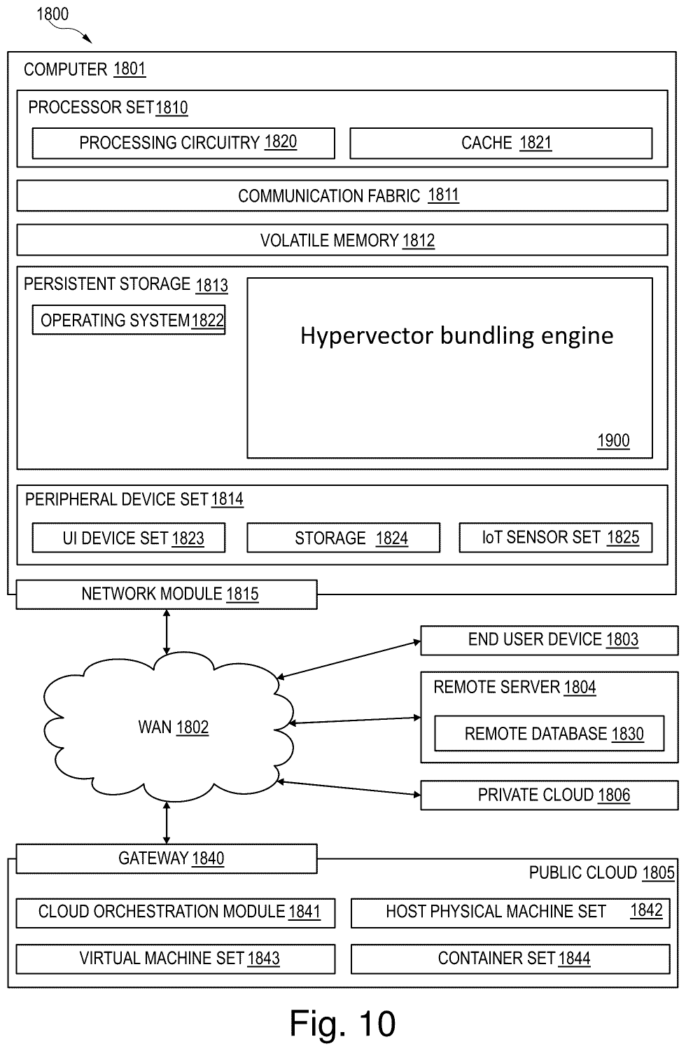

FIG. 9 depicts performance plots 1001 and 1003 in accordance with an embodiment of the invention.

The plots the performance of factorization using the present method of hypervectors each having two blocks or each having four blocks. Problem size M is an indicator of the difficulty of the factorization problem. A larger M implies a more complex problem. Problem size M may indicate the total number of classes. k stands for the number of sparse blocks. As shown in plot 1001, the binary sparse block-codes may achieve an accuracy smaller than 100%. Sparse block codes achieve an accuracy of >99%. As shown in plot 1003, sparse block codes with the present similarity calculation yields up to two orders of magnitude larger operational capacity.

FIG. 10 is a block diagram depicting computing environment 1800 for bundling hypervectors, in accordance with an example of the present subject matter.

Computing environment 1800 contains an example of an environment for the execution of at least some of the computer code involved in performing the inventive methods, such as a hypervector bundling engine 1900. In addition to hypervector bundling engine 1900, computing environment 1800 includes, for example, computer 1801, wide area network (WAN) 1802, end user device (EUD) 1803, remote server 1804, public cloud 1805, and private cloud 1806. In this embodiment, computer 1801 includes processor set 1810 (including processing circuitry 1820 and cache 1821), communication fabric 1811, volatile memory 1812, persistent storage 1813 (including operating system 1822 and hypervector bundling engine 1900, as identified above), peripheral device set 1814 (including user interface (UI) device set 1823, storage 1824, and Internet of Things (IoT) sensor set 1825), and network module 1815. Remote server 1804 includes remote database 1830. Public cloud 1805 includes gateway 1840, cloud orchestration module 1841, host physical machine set 1842, virtual machine set 1843, and container set 1844. COMPUTER 1801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1830. As is well understood in the art of computer technology, and depending upon the technology, performance of a computer-implemented method may be distributed among multiple computers and/or between multiple locations. On the other hand, in this presentation of computing environment 1800, detailed discussion is focused on a single computer, specifically computer 1801, to keep the presentation as simple as possible. Computer 1801 may be located in a cloud, even though it is not shown in a cloud in FIG. 10. On the other hand, computer 1801 is not required to be in a cloud except to any extent as may be affirmatively indicated.

PROCESSOR SET 1810 includes one, or more, computer processors of any type now known or to be developed in the future. Processing circuitry 1820 may be distributed over multiple packages, for example, multiple, coordinated integrated circuit chips. Processing circuitry 1820 may implement multiple processor threads and/or multiple processor cores. Cache 1821 is memory that is located in the processor chip package(s) and is typically used for data or code that should be available for rapid access by the threads or cores running on processor set 1810. Cache memories are typically organized into multiple levels depending upon relative proximity to the processing circuitry. Alternatively, some, or all, of the cache for the processor set may be located “off chip.” In some computing environments, processor set 1810 may be designed for working with qubits and performing quantum computing.

Computer readable program instructions are typically loaded onto computer 1801 to cause a series of operational steps to be performed by processor set 1810 of computer 1801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1821 and the other storage media discussed below. The program instructions, and associated data, are accessed by processor set 1810 to control and direct performance of the inventive methods. In computing environment 1800, at least some of the instructions for performing the inventive methods may be stored in hypervector bundling engine 1900 in persistent storage 1813.

COMMUNICATION FABRIC 1811 is the signal conduction path that allows the various components of computer 1801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1812 is any type of volatile memory now known or to be developed in the future. Examples include dynamic type random access memory (RAM) or static type RAM. Typically, volatile memory 1812 is characterized by random access, but this is not required unless affirmatively indicated. In computer 1801, the volatile memory 1812 is located in a single package and is internal to computer 1801, but, alternatively or additionally, the volatile memory may be distributed over multiple packages and/or located externally with respect to computer 1801.

PERSISTENT STORAGE 1813 is any form of non-volatile storage for computers that is now known or to be developed in the future. The non-volatility of this storage means that the stored data is maintained regardless of whether power is being supplied to computer 1801 and/or directly to persistent storage 1813. Persistent storage 1813 may be a read only memory (ROM), but typically at least a portion of the persistent storage allows writing of data, deletion of data and re-writing of data. Some familiar forms of persistent storage include magnetic disks and solid state storage devices. Operating system 1822 may take several forms, such as various known proprietary operating systems or open source Portable Operating System Interface-type operating systems that employ a kernel. The code included in hypervector bundling engine 1900 typically includes at least some of the computer code involved in performing the inventive methods.

PERIPHERAL DEVICE SET 1814 includes the set of peripheral devices of computer 1801. Data communication connections between the peripheral devices and the other components of computer 1801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1823 may include components such as a display screen, speaker, microphone, wearable devices (such as goggles and smart watches), keyboard, mouse, printer, touchpad, game controllers, and haptic devices. Storage 1824 is external storage, such as an external hard drive, or insertable storage, such as an SD card. Storage 1824 may be persistent and/or volatile. In some embodiments, storage 1824 may take the form of a quantum computing storage device for storing data in the form of qubits. In embodiments where computer 1801 is required to have a large amount of storage (for example, where computer 1801 locally stores and manages a large database) then this storage may be provided by peripheral storage devices designed for storing very large amounts of data, such as a storage area network (SAN) that is shared by multiple, geographically distributed computers. IoT sensor set 1825 is made up of sensors that can be used in Internet of Things applications. For example, one sensor may be a thermometer and another sensor may be a motion detector.

NETWORK MODULE 1815 is the collection of computer software, hardware, and firmware that allows computer 1801 to communicate with other computers through WAN 1802. Network module 1815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1815 are performed on the same physical hardware device. In other embodiments (for example, embodiments that utilize software-defined networking (SDN)), the control functions and the forwarding functions of network module 1815 are performed on physically separate devices, such that the control functions manage several different network hardware devices. Computer readable program instructions for performing the inventive methods can typically be downloaded to computer 1801 from an external computer or external storage device through a network adapter card or network interface included in network module 1815.

WAN 1802 is any wide area network (for example, the internet) capable of communicating computer data over non-local distances by any technology for communicating computer data, now known or to be developed in the future. In some embodiments, the WAN 1802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1803 is any computer system that is used and controlled by an end user (for example, a customer of an enterprise that operates computer 1801), and may take any of the forms discussed above in connection with computer 1801. EUD 1803 typically receives helpful and useful data from the operations of computer 1801. For example, in a hypothetical case where computer 1801 is designed to provide a recommendation to an end user, this recommendation would typically be communicated from network module 1815 of computer 1801 through WAN 1802 to EUD 1803. In this way, EUD 1803 can display, or otherwise present, the recommendation to an end user. In some embodiments, EUD 1803 may be a client device, such as thin client, heavy client, mainframe computer, desktop computer and so on.

REMOTE SERVER 1804 is any computer system that serves at least some data and/or functionality to computer 1801. Remote server 1804 may be controlled and used by the same entity that operates computer 1801. Remote server 1804 represents the machine(s) that collect and store helpful and useful data for use by other computers, such as computer 1801. For example, in a hypothetical case where computer 1801 is designed and programmed to provide a recommendation based on historical data, then this historical data may be provided to computer 1801 from remote database 1830 of remote server 1804.

PUBLIC CLOUD 1805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 1805 is performed by the computer hardware and/or software of cloud orchestration module 1841. The computing resources provided by public cloud 1805 are typically implemented by virtual computing environments that run on various computers making up the computers of host physical machine set 1842, which is the universe of physical computers in and/or available to public cloud 1805. The virtual computing environments (VCEs) typically take the form of virtual machines from virtual machine set 1843 and/or containers from container set 1844. It is understood that these VCEs may be stored as images and may be transferred among and between the various physical machine hosts, either as images or after instantiation of the VCE. Cloud orchestration module 1841 manages the transfer and storage of images, deploys new instantiations of VCEs and manages active instantiations of VCE deployments. Gateway 1840 is the collection of computer software, hardware, and firmware that allows public cloud 1805 to communicate through WAN 1802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1806 is similar to public cloud 1805, except that the computing resources are only available for use by a single enterprise. While private cloud 1806 is depicted as being in communication with WAN 1802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1805 and private cloud 1806 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

1. A computer-implemented method for bundling a set of hypervectors, the computer-implemented method comprising:
calculating, by a processor, a sum hypervector, wherein the sum hypervector is an element-wise sum from a set of hypervectors;
determining, by the processor, a plurality of blocks of the sum hypervector;
selecting, by the processor, from each of the plurality of blocks one or more elements of the sum hypervector based on a selection criterion; and
setting, by the processor, non-selected elements of the sum hypervector to zero.

2. The computer-implemented method of claim 1, wherein the selection criterion is a predefined number of largest elements per block of the sum hypervector.

3. The computer-implemented method of claim 1, wherein the selection criterion is whether the element of the block exceeds a threshold value and if no element exceeds the threshold value in a block, all elements of the block are selected.

4. The computer-implemented method of claim 1, further comprising:
normalizing, by the processor, each block of the plurality of blocks.

5. The computer-implemented method of claim 1, wherein each of the set hypervectors are a predetermined dimension, and wherein each of the set of hypervector are binary values and a sparsity smaller than a sparsity threshold, wherein sparsity represents a fraction of non-zero values in the hypervector.

6. The computer-implemented method of claim 5, wherein the sparsity threshold is a range of: 0.3%-50%.

7. The computer-implemented method of claim 1, further comprising:
binding, by the processor, the bundled hypervectors using a circular convolution or unbinding the hypervectors using a circular correlation.

8. A computer system for bundling a set of hypervectors, the computer system the system comprising:
one or more computer processors;
one or more computer readable storage devices; and
a plurality of computer program instructions stored on the one or more computer readable storage devices, executable by the processor to perform one or more operations, the operations comprising:
calculate a sum hypervector, wherein the sum hypervector is an element-wise sum from a set of hypervectors;
determine a plurality of blocks of the sum hypervector;
select from each of the plurality of blocks one or more elements of the sum hypervector based on a selection criterion; and
set the non-selected elements of the sum hypervector to zero.

9. The computer system of claim 8, wherein the selection criterion is a predefined number of largest elements per block of the sum hypervector.

10. The computer system of claim 8, wherein the selection criterion is whether the one or more elements of the block exceeds a threshold value and if no element of the one or more elements exceeds the threshold value in a block, all elements of the block are selected.

11. The computer system of claim 8, further comprising operations to:
normalize each block of the plurality of blocks.

12. The computer system of claim 8, wherein each one of the set hypervectors are a predetermined dimension, and wherein each of the set of hypervector are binary values and a sparsity smaller than a sparsity threshold, wherein sparsity represents a fraction of non-zero values in the hypervector.

13. The computer system of claim 12, wherein the sparsity threshold is a range of: 0.3%-50%.

14. The computer system of claim 8, further comprising operations to:
bind the bundled hypervectors based on a circular convolution or unbinding the hypervectors based on a circular correlation.

15. A computer program product for bundling a set of hypervectors, the computer program product comprising, a computer readable storage device having program instructions embodied therewith, the program instructions executable by a processor to cause the processors to perform one or more operations, the one or more operations comprising:
calculate a sum hypervector, wherein the sum hypervector is an element-wise sum from a set of hypervectors;
determine a plurality of blocks of the sum hypervector;
select from each of the plurality of blocks one or more elements of the sum hypervector based on a selection criterion; and
set the non-selected elements of the sum hypervector to zero.

16. The computer program product of claim 15, wherein the selection criterion is a predefined number of largest elements per block of the sum hypervector.

17. The computer program product of claim 15, wherein the selection criterion is whether the one or more elements of the block exceeds a threshold value and if no element of the one or more elements exceeds the threshold value in a block, all elements of the block are selected.

18. The computer program product of claim 15, further comprising program instructions to:
normalize each block of the plurality of blocks.

19. The computer program product of claim 15, wherein each one of the set hypervectors are a predetermined dimension, and wherein each of the set of hypervector are binary values and a sparsity smaller than a sparsity threshold, wherein sparsity represents a fraction of non-zero values in the hypervector.

20. The computer program product of claim 15, further comprising program instructions to:
bind the bundled hypervectors based on a circular convolution or unbinding the hypervectors based on a circular correlation.
